(19) United States
(12) Patent Application Publication
(10) Pub. No.: US 2014/0125957 A1
(43) Pub. Date: May 8, 2014

(54) LIGHT FIELD DISPLAY APPARATUS AND METHOD

(71) Applicant: SAMSUNG ELECTRONICS CO., LTD., Suwon-si (KR)

(72) Inventors: Jin Ho LEE, Suwon-si (KR); Ju Yong PARK, Seongnam-si (KR); Dong-Kyung NAM, Yongin-si (KR); Seo Young CHOI, Seoul (KR)

(73) Assignee: SAMSUNG ELECTRONICS CO., LTD., Suwon-si (KR)

(21) Appl. No.: 13/857,644

(22) Filed: Apr. 5, 2013

(30) Foreign Application Priority Data
Nov. 5, 2012 (KR) 10- 2012- 0124271
Nov. 23, 2012 (KR) 10-2012-0133402

(51) Int. Cl. G03B 21/14

(52) U.S. Cl. CPC G03B 21/14
USPC 353/37; 353/30

(57) ABSTRACT

A light field display apparatus includes a plurality of projectors to emit rays, and a screen to display the rays emitted by the plurality of projectors. Positions of the plurality of projectors may be controlled so that intervals or angles between the rays displayed on the screen are substantially the same.

### CROSS-REFERENCE TO RELATED APPLICATIONS

This application claims the priority benefit of Korean Patent Application Nos. 10-2012-0124271, filed on Nov. 5, 2012, and 10-2012-0133402, filed on Nov. 23, 2012, in the Korean Intellectual Property Office, the disclosure of which is incorporated herein by reference.

### BACKGROUND

1. Field

One or more example embodiments of the following description relate to a light field display apparatus and method, and more particularly, to a light field display apparatus and method adjusting positions of a plurality of projectors, angles between the projectors, and projection distances.

2. Description of the Related Art

According to the recent spread of 3-dimensional (3D) content, a with-glasses 3D TV and a glasses-free 3D TV are provided. The with-glasses 3D TV provides a 3D image through polarizing glasses. Therefore, the with-glasses 3D TV causes users an inconvenience of wearing glasses. Also, the users may feel fatigue during watching due to conflicts between accommodation and vergence.

The glasses-free 3D TV provides a 3D image through a lenticular lens and the like.

The glasses-free 3D TV includes a multi-view display and a super multi-view display. The multi-view display or the super multi-view display may generate a multi-view image or super multi-view image by synthesizing rays output from a plurality of projectors by a light field synthesis method. Therefore, the multi-view image or super multi-view image may be displayed on a screen. Hereinafter, the multi-view image or super multi-view image will be collectively referred to as a 3D image.

When the number of projectors is increased, the 3D depth resolution of the 3D image is increased so a depth of the 3D image may be finely expressed. However, uniformity in brightness distribution of the 3D may be reduced. For example, as the number of projectors is increased, a keystone phenomenon of the projectors may become serious. Also, a keystone variation between the projectors may be increased. Accordingly, intervals between the rays displayed on the screen may not be uniform.

### SUMMARY

The foregoing described problems may be overcome and/or other aspects may be achieved by one or more embodiments of a light field display apparatus that may include a plurality of projectors to emit rays, a screen to display the rays emitted by the plurality of projectors, wherein positions of the plurality of projectors may be controlled so that intervals between the rays displayed on the screen are substantially the same.

Arrangement orders of the plurality of projectors may be controlled to be different between even number rows and odd number rows.

Rows on which the plurality of projectors are arranged may be repeatedly changed according to a predetermined row interval.

Projection distances of the plurality of projectors may be controlled according to a size of the screen.

Positions of the plurality of projectors may be controlled such that angles between the rays emitted toward the screen by the plurality of projectors are substantially the same.

The light field display apparatus may further include a reflection mirror tilted by a predetermined angle with respect to the screen to reflect the rays emitted by the plurality of projectors.

The foregoing described problems may be overcome and/or other aspects may be achieved by one or more embodiments of a light field display apparatus that may include a plurality of projectors to emit rays, and a screen to display the rays emitted by the plurality of projectors, wherein positions of the plurality of projectors may be controlled so that angles between the rays emitted toward the screen by the plurality of projectors are substantially the same.

The light field display apparatus may further include a first reflection mirror disposed at one side of the screen and tilted with respect to the screen by a predetermined angle, to reflect the rays emitted by the plurality of projectors, and a second reflection mirror disposed at an opposite side of the screen and tilted with respect to the screen by a predetermined angle, to reflect the rays emitted by the plurality of projectors.

Projection distances of the plurality of projectors may be controlled according to a size of the screen.

Positions of the plurality of projectors may be controlled such that intervals between the rays displayed on the screen are substantially the same.

The foregoing described problems may be overcome and/or other aspects may be achieved by one or more embodiments of a light field display apparatus that may include a plurality of projectors to emit rays, and a screen to display the rays emitted from the plurality of projectors, wherein projection distances of the plurality of projectors may be controlled according to a size of the screen.

The projection distances of the plurality of projectors may be controlled such that the plurality of projectors are arranged on an imaginary circle having an arc length equal to a horizontal length or vertical length of the screen.

The projection distances may be controlled such that the plurality of projectors are directed toward the screen or opposite to the screen according to a tilting value of the plurality of projectors, and the tilting value may include a tilt of each of the plurality of projectors with respect to at least one projector arranged parallel toward the screen among the plurality of projectors.

The foregoing described problems may be overcome and/or other aspects may be achieved by one or more embodiments of a light field display method that may include emitting rays from a plurality of projectors, and displaying the rays emitted from the plurality of projectors on a screen, wherein positions of the plurality of projectors may be controlled such that intervals between the rays displayed on the screen are substantially the same.

Arrangement orders of the plurality of projectors may be different between even number rows and odd number rows.

Rows on which the plurality of projectors are arranged may be repeatedly changed according to a predetermined row interval.

Projection distances of the plurality of projectors may be controlled according to a size of the screen.

Positions of the plurality of projectors may be controlled such that angles between the rays emitted toward the screen by the plurality of projectors are substantially the same.

The foregoing described problems may be overcome and/or other aspects may be achieved by one or more embodiments of a light field display method that may include emitting rays from a plurality of projectors, and displaying the rays emitted by the plurality of projectors on a screen, wherein positions of the plurality of projectors may be controlled so that angles between the rays emitted toward the screen by the plurality of projectors are substantially the same.

The foregoing described problems may be overcome and/or other aspects may be achieved by one or more embodiments of a light field display method performed by a light field display apparatus, that may include emitting rays from a plurality of projectors, and displaying the rays emitted by the plurality of projectors on a screen, wherein projection distance of the plurality of projectors may be controlled according to a size of the screen.

Additional aspects and/or advantages of one or more embodiments will be set forth in part in the description which follows and, in part, will be apparent from the description, or may be learned by practice of one or more embodiments of disclosure. One or more embodiments are inclusive of such additional aspects.

### BRIEF DESCRIPTION OF THE DRAWINGS

These and/or other aspects and advantages will become apparent and more readily appreciated from the following description of example embodiments, taken in conjunction with the accompanying drawings of which:

FIG. 1 illustrates a configuration of a light field display apparatus according to one or more example embodiments;

FIG. 2 illustrates a configuration of a light field display apparatus according to one or more example embodiments;

FIG. 3 illustrates operation of controlling positions of projectors according to a row interval by a light field display apparatus according to one or more example embodiments;

FIG. 4 illustrates a configuration of a light field display apparatus according to one or more example embodiments;

FIG. 5 illustrates a light field display apparatus in which projection distances are controlled using an arc of a circle, according to one or more example embodiments;

FIG. 6 illustrates a light field display apparatus in which projection distances are controlled using an area of a screen, according to one or more example embodiments;

FIG. 7 illustrates brightness distribution of a 3-dimensional (3D) image provided by a light field display apparatus, according to one or more example embodiments;

FIG. 8 illustrates a flowchart of a light field display method in which positions of a plurality of projectors are controlled so that intervals between rays are substantially the same, according to one or more example embodiments;

FIG. 9 illustrates a flowchart of a light field display method in which positions of a plurality of projectors are controlled so that angles between rays are substantially the same, according to one or more example embodiments; and

FIG. 10 illustrates a flowchart of a light field display method in which projection distances of a plurality of projectors are controlled, according to one or more example embodiments.

### DETAILED DESCRIPTION

Reference will now be made in detail to one or more embodiments, illustrated in the accompanying drawings, wherein like reference numerals refer to like elements throughout. In this regard, embodiments of the present invention may be embodied in many different forms and should not be construed as being limited to embodiments set forth herein, as various changes, modifications, and equivalents of the systems, apparatuses and/or methods described herein will be understood to be included in the invention by those of ordinary skill in the art after embodiments discussed herein are understood. Accordingly, embodiments are merely described below, by referring to the figures, to explain aspects of the present invention.

The light field display apparatus and method according to example embodiments may display a multi-view image and a super multi-view image.

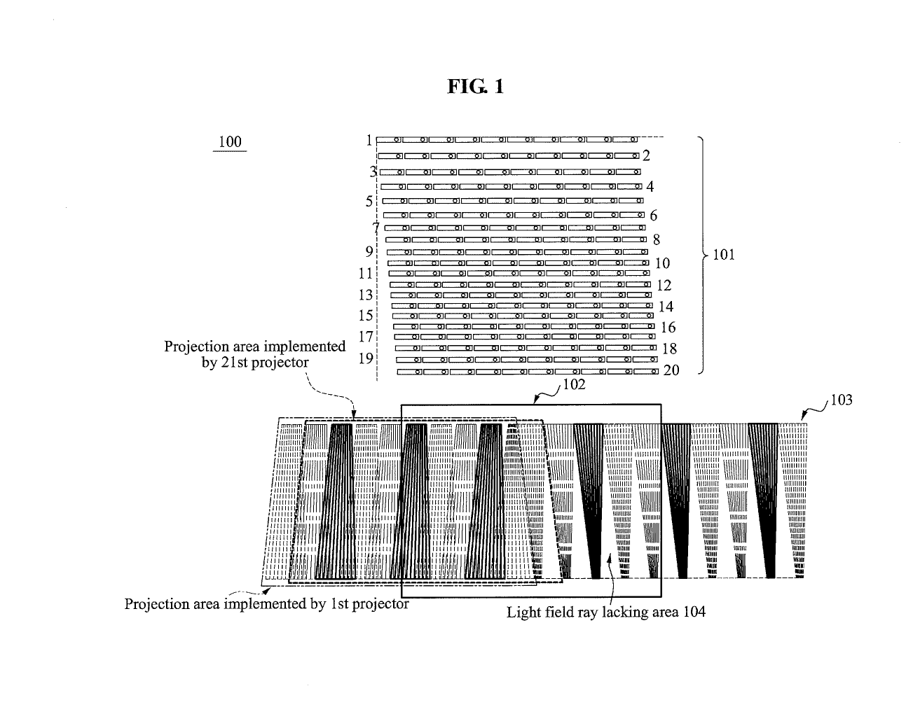

FIG. 1 illustrates a configuration of a light field display apparatus 100 according to one or more example embodiments.

In particular, FIG. 1 shows the configuration of the light field display apparatus 100 that displays a 3-dimensional (3D) image without changing an arrangement order of a plurality of projectors.

Referring to FIG. 1, the light field display apparatus 100 may include a plurality of projectors 101 and a screen 102.

The plurality of projectors 101 may emit rays forming a multi-view image or a super multi-view image. Therefore, the screen 102 may display the rays emitted from the plurality of projectors 101.

The plurality of projectors 101 may each include a spatial light modulator (SLM). The plurality of projectors 101 may be expressed as an optical module which is a micro display. For example, the projectors 101 may emit the rays through high-speed switching of the SLM. Therefore, the multi-view image or the super multi-view image generated by overlapping of the emitted rays may be displayed on the screen 102.

Due to the rays emitted onto a surface of the screen 102 by the plurality of projectors 101, a projection area 103 for an image may be generated on the surface of the screen 102.

The projection area 103 may be extended wider than the screen 102 in lateral directions with respect to an area of the screen 102 according to arrangement positions of the plurality of projectors 101. A projection area beyond the screen 102 may be gathered into the screen 102 by reflection mirrors (not shown). For example, the reflection mirrors (not shown) may be disposed between the screen 102 and the plurality of projectors 101 to face each other.

A keystone shape may be changed according to a difference in the arrangement positions of the plurality of projectors with respect to a height direction. For example, in a case in which N rows×M columns projectors are arranged in the light field display apparatus 100, where N is 20 and M is 10, and projectors 101 disposed on a row 1 to a row 20 are sequentially shifted at equal intervals, the projection area 103 may have repetitive patterns grouped in units of twenty projectors.

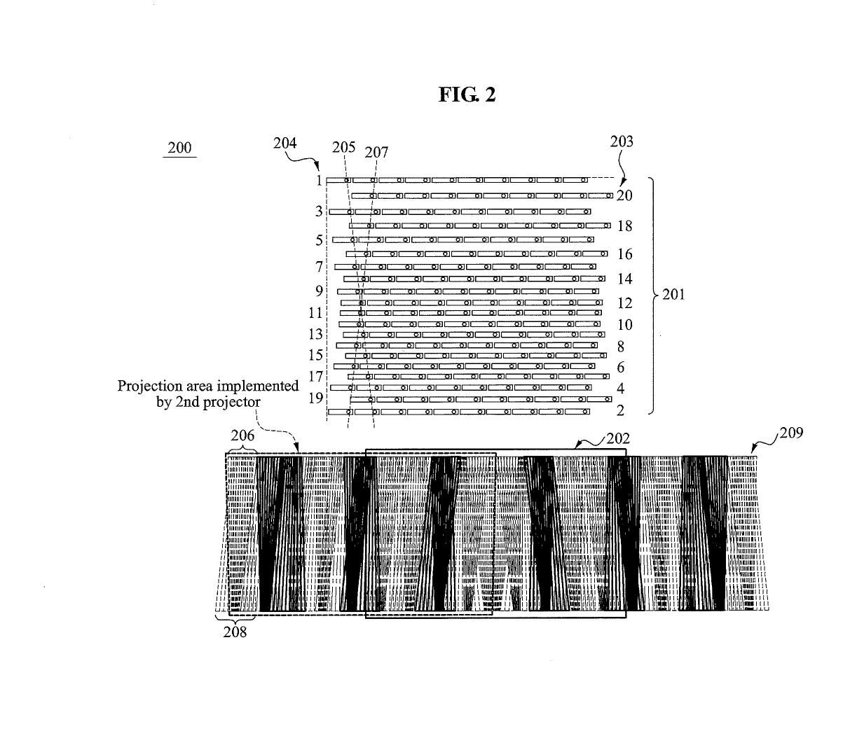

In this case, a difference in intervals between the rays may be generated significantly in a lateral direction at a right side of the projection area 103 in the drawing, the right side may look like a vacant space 104. Due to the vacant space 104 generated by increased intervals between the rays, non-uniformity in brightness of a light field image may become significant. To reduce or prevent the non-uniformity in brightness, positions of the plurality of projectors 101 may be controlled such that the intervals between the rays displayed on the screen 102 are substantially the same. Hereinafter, the operation of controlling the positions of the projectors 101 for equal intervals of the rays will be described in detail with reference to FIG. 2.

FIG. 2 illustrates a configuration of a light field display apparatus 200 according to one or more example embodiments.

In particular, the light field display apparatus 200 of FIG. 2 may display a 3D image by changing arrangement orders of a plurality of projectors 201.

Referring to FIG. 2, the light field display apparatus 200 may include a plurality of projectors 201 and a screen 202.

The plurality of projectors 201 may emit rays forming a multi-view image or a super multi-view image. Therefore, the screen 202 may display the rays emitted from the plurality of projectors 201.

The projectors 201 may each include a spatial light modulator (SLM). The projectors 201 may be implemented by an optical module which is a micro display. For example, the projectors 201 may emit the rays through high-speed switching of the SLM. Therefore, the multi-view image or the super multi-view image generated by overlapping of the emitted rays may be displayed on the screen 202.

In addition, positions of the plurality of projectors 201 may be controlled such that intervals between the rays displayed on the screen 202 are substantially the same.

For example, when the light field display apparatus 200 includes N×M projectors, the arrangement orders of the plurality of projectors 201 may be controlled to be different between even number rows 2N and odd number rows 2N−1 on which the plurality of projectors 201 are arranged.

For example, presuming that N is 20 and M is 10 and that projectors 201 arranged on a row 1 to a row 20 are shifted at equal intervals with reference to projectors 201 of the row 1, the projectors 201 arranged on the even number rows 2, 4, 6, 8, 10, 12, 14, 16, 18, and 20 may be arranged in a descending order. That is, ten projectors of the row 20 may be disposed on the second row which is a highest-order even number row, ten projectors of the row 18 may be disposed on the fourth row, and ten projectors of the row 16 may be disposed on the sixth row. Thus, ten projectors of the rows 14, 12, 10, 8, 6, 4, and 2 may be disposed on the eighth, tenth, twelfth, fourteenth sixteenth, eighteenth and twentieth rows, respectively.

Thus, when the arrangement order of the projectors 201 of the even number rows is controlled to be the descending order, positions of projectors 204 disposed on the odd number rows may be maintained without change. Accordingly, the all projectors may be controlled to be arranged in order of rows 1, 20, 3, 18, 5, 16, 7, 14, 9, 12, 11, 10, 13, 8, 15, 6, 17, 4, 19, and 2.

Therefore, on a projection area 209 of an image formed at a surface of the screen 202, rays 208 emitted from projectors 205 corresponding to a column 1 of the odd number rows and rays 206 emitted from projectors 207 corresponding to a column 1 of the even number rows may be added, thereby possibly being displayed as repetitive patterns grouped in units of twenty projectors.

Next, rays emitted from projectors corresponding to a column 2 of the odd number rows, a column 2 of the even number rows, column 3 of the odd number rows, a column 3 of the even number rows, and so on through a column 10 of the odd number rows, and a column 10 of the even number rows may be repeatedly displayed from a left to a right of the projection area 209 of the image formed on the surface of the screen 202.

In the same manner, the arrangement order of the projectors disposed on the odd number rows 1, 3, 5, 7, 9, 11, 13, 15, 17, and 19 may be controlled to be a descending order. That is, ten projectors of the row 19 may be disposed on the first row, which is a highest-order odd number row, ten projectors of the row 17 may be disposed on the third row, and ten projectors of the row 15 may be disposed on the fifth row. Thus, ten projectors of the rows 13, 11, 9, 7, 5, 3, and 1 may be disposed on the seventh, ninth, eleventh, thirteenth, fifteenth, seventeenth and nineteenth rows, respectively.

When the projectors disposed on the odd number rows are controlled to be arranged in the descending order, positions of projectors disposed on the even number rows may be maintained without change. Accordingly, the all projectors included in the light field display apparatus 200 may be controlled to be arranged in order of rows 19, 2, 17, 4, 15, 6, 13, 8, 11, 10, 9, 12, 7, 14, 5, 16, 3, 18, 1, and 20.

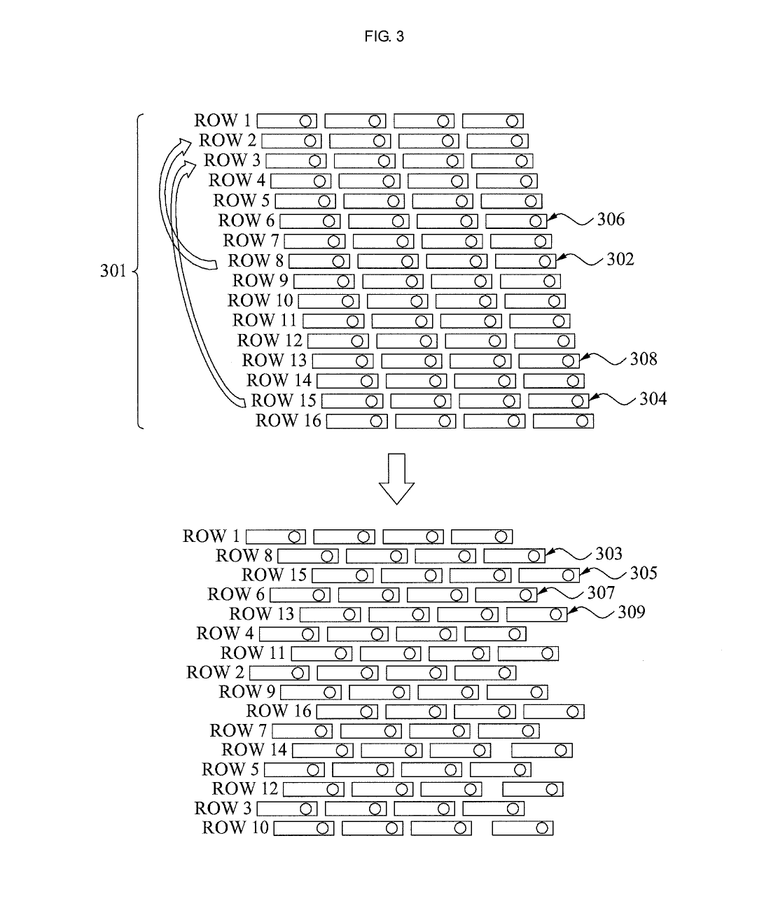

As another example, the rows on which the plurality of projectors 201 are arranged may be repeatedly changed according to a predetermined row interval. In this case, the positions of the plurality of projectors 201 may be controlled such that the intervals between the rays displayed on the screen 202 are substantially the same within a tolerance range. Here, the rows changed according to the predetermined row interval will be described with reference to FIG. 3.

FIG. 3 illustrates operation of controlling positions of projectors according to a row interval by a light field display apparatus according to one or more example embodiments.

Referring to FIG. 3, rows on which a plurality of projectors 301 are arranged may be repeatedly changed according to a predetermined row interval.

For example, when N is 16, M is 4, and the row interval is predetermined to 7, projectors disposed on the row 8 (302) corresponding to a 7-row interval with reference to the row 1 may be changed to be disposed on the row 2 (303). Next, projectors disposed on a row 15 (304) corresponding to a 7-row interval with reference to the row 8 (302) before the position change to the row 2 (303) may be changed to be disposed on the row 3 (305).

From the row 16, positions of the projectors may be changed by a 7-row interval again from the positions of the row 1. That is, projectors disposed on the row 6 (306) corresponding to a 7-row interval with reference to the row 15 (304) before the position change to the row 3 (305) may be changed to be disposed on the row 4 (307).

Next, projectors disposed on the row 13 (308) corresponding to a 7-row interval with reference to the row 6 (306) may be changed to be disposed on the row 5 (309). In the same manner, the position change according to the predetermined row interval may be repeated until projectors disposed on initial positions of the row 6 to the row 16 are disposed on rows corresponding to a 7-row interval, respectively.

When the position change is performed according to the 7-row interval, the plurality of projectors may be arranged in order of rows 1, 8, 15, 6, 13, 4, 11, 2, 9, 16, 7, 14, 5, 12, 3, and 10.

As illustrated with reference to FIGS. 2 and 3, 1) when the arrangement orders of the projectors are controlled to be different between the even number rows and the odd number row, or 2) when the arrangement order of the rows on which the plurality of projectors are arranged is changed according to the row interval, the intervals of the rays displayed on the screen may be substantially the same within the tolerance range. Accordingly, the rays may be displayed without generating a vacant space on the screen. Also, non-uniformity in brightness may be reduced.

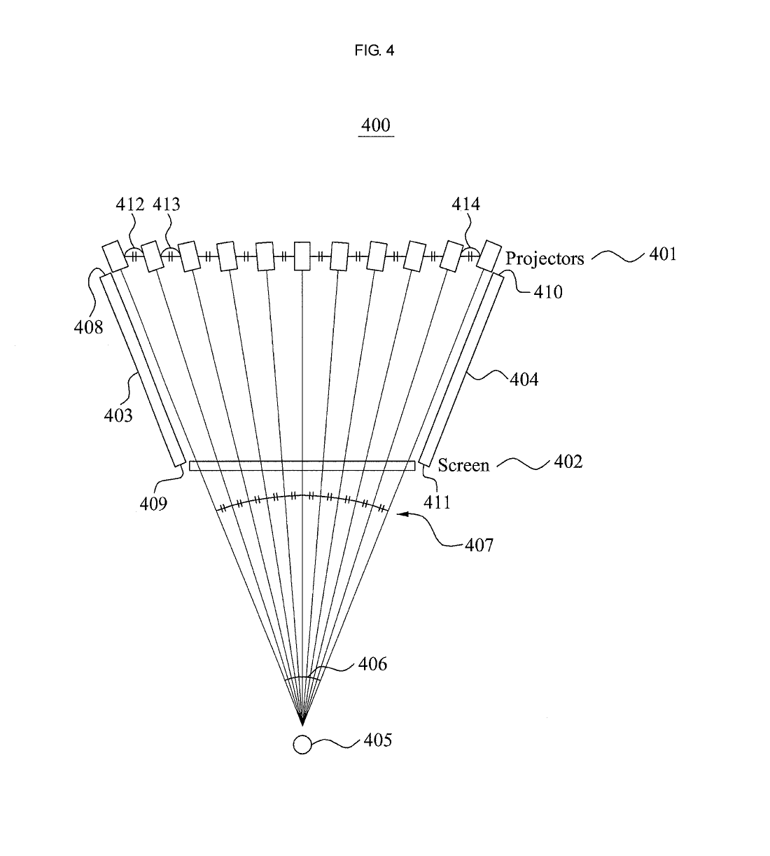

FIG. 4 illustrates a configuration of a light field display apparatus 400 according to one or more example embodiments.

In particular, FIG. 4 shows a plurality of projectors 401 seen from above, which may be arranged in N rows×M columns toward a screen 402.

Referring to FIG. 4, the light field display apparatus 400 may include the plurality of projectors 401, a screen 402, a first reflection mirror 403, and a second reflection mirror 404.

The plurality of projectors 401 may emit rays forming a multi-view image or a super multi-view image. Therefore, the screen 402 may display the rays emitted from the plurality of projectors 401.

Positions of the plurality of projectors 401 may be controlled such that angles between the rays emitted toward the screen 402 by the plurality of projectors 401 are substantially the same. Here, the angles between the rays may be controlled to be substantially the same within a tolerance range.

For example, the angles between the rays may be controlled to be substantially the same based on a center angle 406 of an imaginary focus 405 at which an imaginary extension line of the first reflection mirror 403 and an imaginary extension line of the second reflection mirror 404 meet. Here, the first reflection mirror 403 may be disposed at one side of the screen 402 and tilted by a predetermined angle with respect to the screen 402, thereby possibly reflecting the rays emitted from the plurality of projectors 401 to the screen 402.

The second reflection mirror 404 may be disposed at an opposite side of the screen 402 and tilted by a predetermined angle with respect to the screen 402, thereby possibly reflecting the rays emitted from the plurality of projectors 401 to the screen 402. Thus, the center angle 406 of the imaginary focus 405 may be calculated since the first reflection mirror 403 and the second reflection mirror 404 are tilted by the predetermined angles with respect to the screen 402.

For example, when the center angle A (406) is 22, N is 11, and M is 4, the angles 407 between the rays may be controlled to a value obtained by dividing the angle A=22 by the number of the projectors minus 1, (N×M)−1=43, that is, A/{(N×M)−1}=0.51.

As illustrated in FIG. 4, the positions of the plurality of projectors 401 may be controlled so that the angles 407 between the rays emitted from the plurality of projectors 401 are substantially the same. However, according to one or more embodiments, the positions of the plurality of projectors may also be controlled so that the intervals between the plurality of projectors are substantially the same.

For example, irrespective of the row arrangement of the projectors, a first interval 412 between a projector disposed at a leftmost position and a projector disposed at a next position, that is, a second position, with respect to an imaginary focus O 405, a second interval 413 between a projector disposed at the second position and a projector disposed at a third position with respect to the imaginary focus O 405, . . . , and a tenth interval 414 between a projector disposed at a tenth position and a projector disposed at a eleventh position with respect to the imaginary focus O 405 may be all substantially the same.

The first reflection mirror 403 and the second reflection mirror 404 may be tilted by the predetermined angle with respect to a center of the screen 402. Therefore, one end surface 408 of the first reflection mirror 403 may form a first angle with respect to the projectors whereas an opposite end surface 409 of the first reflection mirror 403 may form a second angle with respect to the screen 402. In the same manner, one end surface 410 of the second reflection mirror 404 may form a third angle with respect to the projectors whereas an opposite end surface 411 may form a fourth angle with respect to the screen 402. Here, the first angle and the third angle may be equal or different. Also, the second angle and the fourth angle may be equal or different.

The first angle to the fourth angle may be determined using the imaginary focus O 405. The imaginary focus O 405 may be an intersection point between a first imaginary extension line connecting the leftmost projector with a left side of the screen 402 and a second imaginary extension line connecting a rightmost projector with a right side of the screen 402.

The first reflection mirror 403 may maintain an angle corresponding to a half of the first interval 412 between the leftmost projector and the next projector. In the same manner, the second reflection mirror 404 may maintain an angle corresponding to a half of the tenth interval 414 between the rightmost projector and a previous projector.

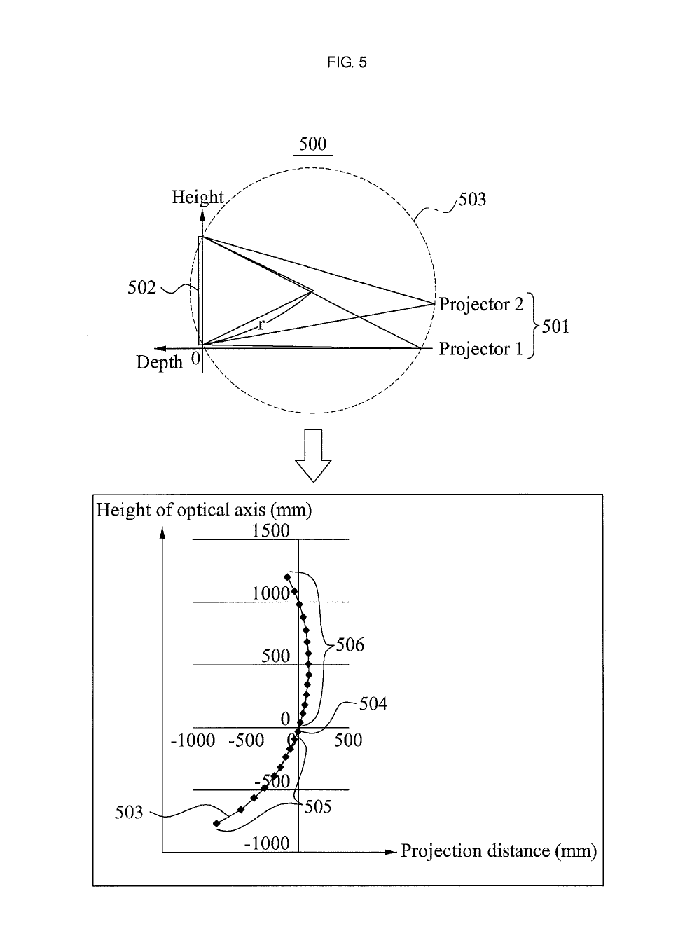

FIG. 5 illustrates a light field display apparatus 500 in which projection distances are controlled using an arc of a circle, according to one or more example embodiments.

In FIG. 5, the projection distances may be controlled in a state in which a plurality of projectors are arranged in a vertical direction with respect to a screen.

Referring to FIG. 5, the light field display apparatus 500 may include a plurality of projectors 501 and a screen 502.

The projection distances of the plurality of projectors 501 may be controlled according to a size of the screen 502. The projection distances may include distances from the screen 502 to the respective projectors 501.

For example, the light field display apparatus 500 may determine a vertical length of the screen 502, an example of the size of the screen 502, to be an arc of a circle. An imaginary circle 503 may be generated using the arc. Next, the plurality of projectors 501 may be arranged on the imaginary circle 503. Therefore, the projection distances of the plurality of projectors 501 may be controlled to be a distance from the plurality of projectors 501 arranged on the imaginary circle 503 to the screen 502.

Together with a reference projector 504 arranged parallel toward the screen 502 among the plurality of projectors 501, the plurality of projectors 501 may be arranged on the imaginary circle 503.

For example, projectors disposed lower than the reference projector 504 when arranged vertical to the screen 502 may be disposed at a lower portion 505 of the reference projector 504 when arranged on the imaginary circle 503. Also, projectors disposed higher than the reference projector 504 when arranged vertical to the screen 502 may be disposed at an upper portion 506 of the reference projector 504 when arranged on the imaginary circle 503. When the plurality of projectors 501 are vertically arranged forming uniform intervals and uniform angles, the projectors 501 may be arranged on the imaginary circle 503 to form uniform intervals and uniform angles.

Thus, when the projection distances are controlled using the vertical length of the screen as the arc of the circle, a vertical length of a 3D image displayed on the screen may be corresponded to the vertical length of the screen. Accordingly, non-uniformity in brightness may be reduced. The 3D image may include a multi-view image and a super multi-view image.

Although FIG. 5 illustrates example embodiments in which the projection distances are controlled using the vertical length of the screen as the arc of the circle, a horizontal length or a diagonal length may also be used as the arc.

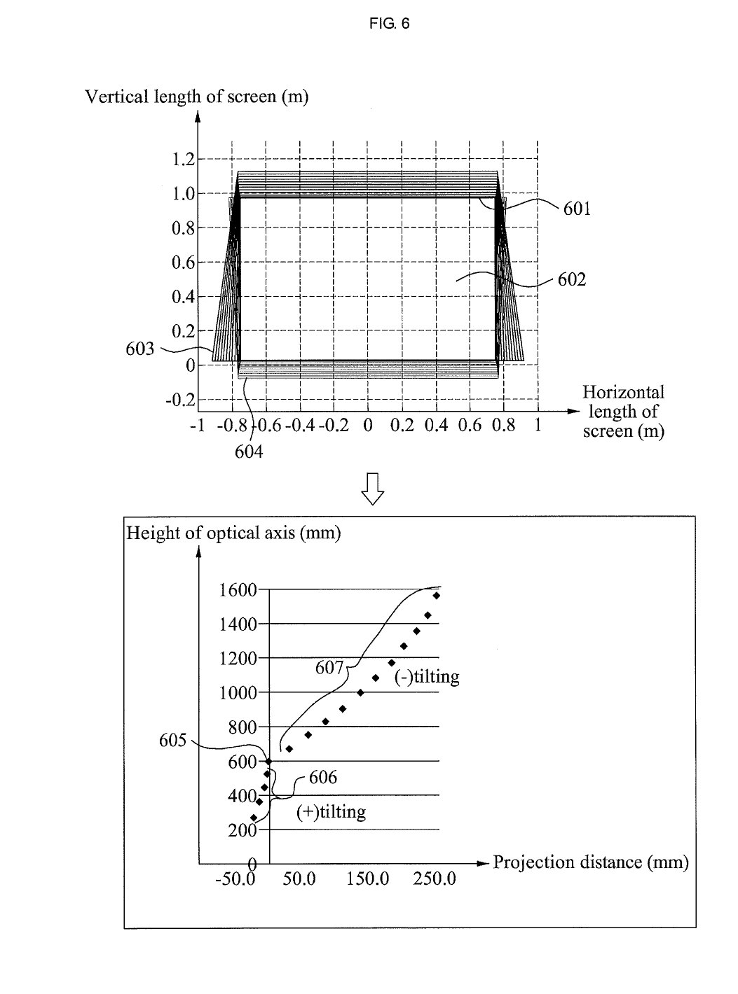

The projection distances may also be controlled using an entire surface area of the screen. Hereinafter, the operation of controlling the projection distances using the entire surface area of the screen will be described with reference to FIG. 6.

FIG. 6 illustrates a light field display apparatus in which projection distances are controlled using an area of a screen 601, according to one or more example embodiments.

In FIG. 6, the projection distances may be controlled in a state in which a plurality of projectors are arranged vertical to the screen 601.

According to FIG. 6, the projection distances of the plurality of projectors may be controlled so that a 3D image emitted by the plurality of projectors and displayed on the screen 601 is larger than the screen 601. That is, the projection distances may be controlled so that sizes 603 and 604 of the image 3D is larger than an entire surface area 602 of the screen.

Here, the projection distances may be controlled by a tilting value of each of the plurality of projectors. The tilting value may include tilt of each of the plurality of projectors with respect to a reference projector 605 arranged parallel toward the screen 601 among the plurality of projectors.

For example, with respect to projectors 606 having a positive tilting value, the projection distances may be controlled in a direction toward the screen in proportion to the positive tilting value. That is, the projectors 606 corresponding to the positive tilting value may be tilted up toward the reference projector 605 at a lower portion of the reference projector 605. Therefore, the projection distances of the projectors tilted up may be controlled to become shorter with respect to the screen 601.

With respect to projectors 607 having a negative tilting value, the projection distances may be controlled in a direction away from the screen 601 in proportion to the negative tilting value. That is, the projectors 607 corresponding to the negative tilting value may be tilted down toward the reference projector 605 at an upper portion of the reference projector 605. Therefore, the projection distances of the projectors tilted down may be controlled to become longer with respect to the screen 601.

As illustrated with reference to FIG. 6, the projection distances may be controlled differently according to the positive tilting value and the negative tilting value. In addition, the projection distances may have an inflection point. The projection distances of the projectors 607 corresponding to the negative tilting value may be controlled by a larger degree according to the negative titling value.

Thus, when the projection distances are controlled using the entire surface area of the screen, the size of the 3D image may become larger than the size of the screen. Therefore, lack of light field rays on the screen may possibly be prevented. As a result, non-uniformity in brightness may possibly be reduced.

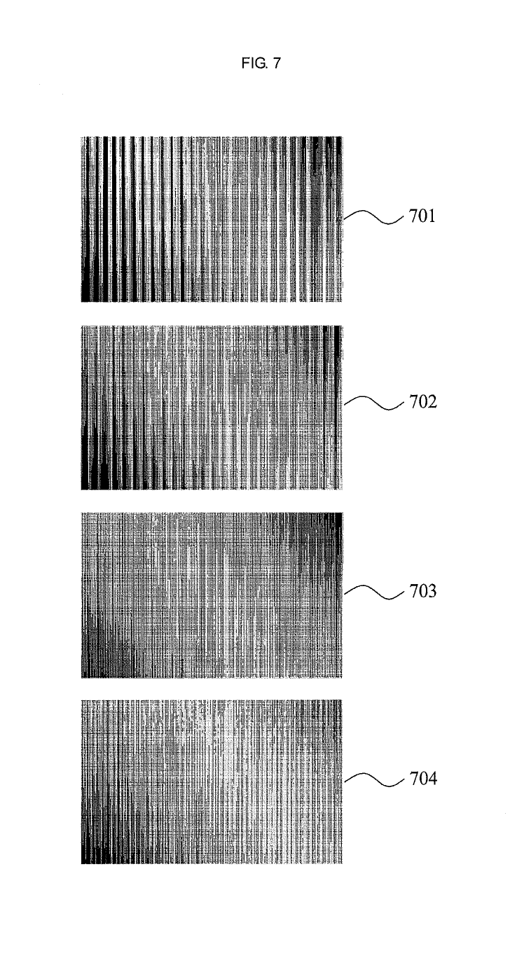

FIG. 7 illustrates brightness distribution of a 3-dimensional (3D) image provided by a light field display apparatus, according to one or more example embodiments.

According to FIG. 7, when a plurality of projectors are sequentially arranged in a vertical direction and when intervals between the plurality of projectors are substantially the same as shown by 701, the brightness distribution of the 3D image displayed on the screen is shown non-uniform. That is, the brightness distribution may be shown in a curtain form in which intervals between rays forming the 3D image are too close or too far.

When the plurality of projectors are sequentially arranged in a vertical direction and when angles between the rays emitted from the plurality of projectors are substantially the same as shown by 702, non-uniformity in brightness of the 3D image may be improved in comparison to 701.

When the arrangement orders of the plurality of projectors are controlled to be different between the even number row and the odd number row and when the positions of the projectors are controlled such that the angles between the rays emitted by the projectors are substantially the same as shown by 703, the non-uniformity in brightness of the 3D image may be improved in comparison to 701 and 702.

Next, when rows of the plurality of projectors are repeatedly changed according to a predetermined row interval and when the positions of the plurality of projectors are controlled such that the angles between the rays emitted by the projectors are substantially the same as shown by 704, the non-uniformity in brightness of the 3D image may be improved in comparison to 701 to 703.

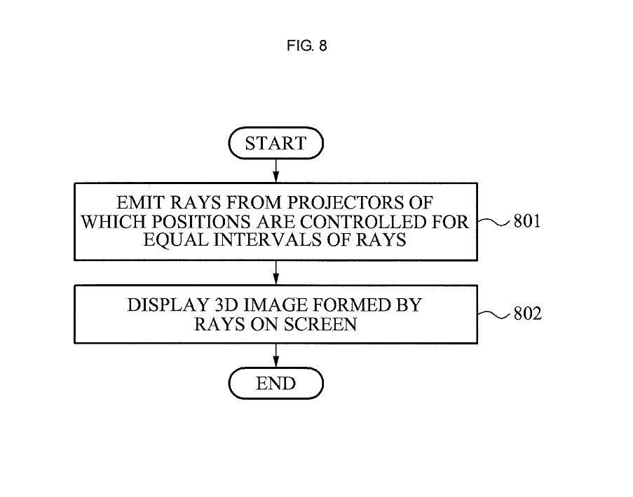

FIG. 8 illustrates a flowchart of a light field display method in which positions of a plurality of projectors are controlled so that intervals between rays are substantially the same, according to one or more example embodiments.

The light field display method of FIG. 8 may be performed by a light field display apparatus, such as the light field display apparatus of FIG. 1 or the light field display apparatus of FIG. 2.

In operation 801, the plurality of projectors may emit rays, respectively. Positions of the plurality of projectors may be controlled such that the intervals between the rays are substantially the same.

For example, the arrangement orders of the plurality of projectors may be controlled to be different.

For example, when N rows×M columns projectors are arranged in which N is 20 and M is 10, projectors disposed on even number rows 2, 4, 6, 8, 10, 12, 14, 16, 18, and 20 may be controlled to be arranged in a descending order. That is, ten projectors of the row 20 may be disposed on the second row which is a highest-order even number row, ten projectors of a row 18 may be disposed on the fourth row, and ten projectors of the row 16 may be disposed on the sixth row. Thus, ten projectors of the rows 14, 12, 10, 8, 6, 4, and 2 may be disposed on the eighth, tenth, twelfth, fourteenth, sixteenth, eighteenth and twentieth rows, respectively.

Thus, when the arrangement order of the projectors of the even number rows is controlled to be the descending order, positions of projectors disposed on the odd number rows may be maintained without change. Accordingly, the all projectors may be controlled to be arranged in order of rows 1, 20, 3, 18, 5, 16, 7, 14, 9, 12, 11, 10, 13, 8, 15, 6, 17, 4, 19, and 2.

In the same manner, the arrangement order of the projectors disposed on the odd number rows 1, 3, 5, 7, 9, 11, 13, 15, 17, and 19 may be controlled to be a descending order.

As another example, the rows on which the plurality of projectors are arranged may be repeatedly changed according to a predetermined row interval.

For example, when N is 16, M is 4, and the row interval is predetermined to 7, projectors disposed on the row 8 corresponding to a 7-row interval with reference to the row 1 may be changed to be disposed on the row 2. Next, projectors disposed on the row 15 corresponding to a 7-row interval with reference to the row 8 before the position change to the row 2 may be changed to be disposed on the row 3. From the row 16, positions of the projectors may be changed by a 7-row interval again from the positions of the row 1. Accordingly, the projectors from the row 1 to the row 16 may be changed to be arranged in order of rows 1, 8, 15, 6, 13, 4, 11, 2, 9, 16, 7, 14, 5, 12, 3, and 10.

Here, the light field display apparatus may reflect the rays emitted from the plurality of projectors, of which the arrangement order is controlled with respect to the even number row and the odd number row or according to the row interval, to the screen using a reflection mirror. Therefore, the rays emitted to the outside of the screen may be reflected to the screen. The reflection mirror may be tilted by a predetermined angle with respect to a center of the screen.

Therefore, in operation 802, the screen may display a 3D image formed by the rays emitted from the plurality of projectors of which the arrangement order is controlled. Here, the 3D image may include a multi-view image and a super multi-view image.

For example, the screen may display the rays emitted from the plurality of projectors on which the arrangement order is controlled with respect to the even number row and the odd number row.

As another example, the screen may display the rays emitted from the plurality of projectors on which the arrangement order is controlled according to the predetermined row interval.

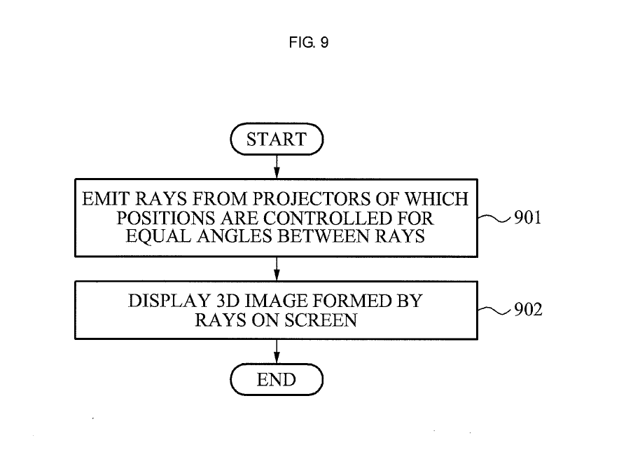

FIG. 9 illustrates a flowchart of a light field display method in which positions of a plurality of projectors are controlled so that angles between rays are substantially the same, according to one or more example embodiments.

The light field display method of FIG. 9 may be performed by a light field display, such as the light field display apparatus of FIG. 4.

In operation 901, the plurality of projectors may emit rays, respectively. Here, positions of the plurality of projectors may be controlled such that angles between the rays emitted by the plurality of projectors toward the screen are substantially the same. The angles may be controlled to be substantially the same within a tolerance range.

For example, the positions of the plurality of projectors may be controlled such that the angles between the rays are substantially the same based on a center angle of an imaginary focus at which an imaginary extension line of a first reflection mirror and an imaginary extension line of a second reflection mirror meet. The center angle of the imaginary focus may be calculated since the first reflection mirror and the second reflection mirror are tilted by the predetermined angles with respect to the screen.

The first reflection mirror may be disposed at one side of the screen and tilted by a predetermined angle with respect to the screen. The first reflection mirror may reflect, toward the screen, rays emitted beyond the one side of the screen among the rays emitted from the plurality of projectors of which positions are controlled.

The second reflection mirror may be disposed at an opposite side of the screen and tilted by a predetermined angle with respect to the screen. The second reflection mirror may reflect, toward the screen, rays emitted beyond the opposite side of the screen among the rays emitted from the plurality of projectors of which positions are controlled.

For example, when the center angle A is 22, N is 11, and M is 4, the angles between the rays may be controlled to A/{(N×M)−1}=0.51 obtained by dividing the angle A=22 by the number of the projectors minus 1, (N×M)−1=43.

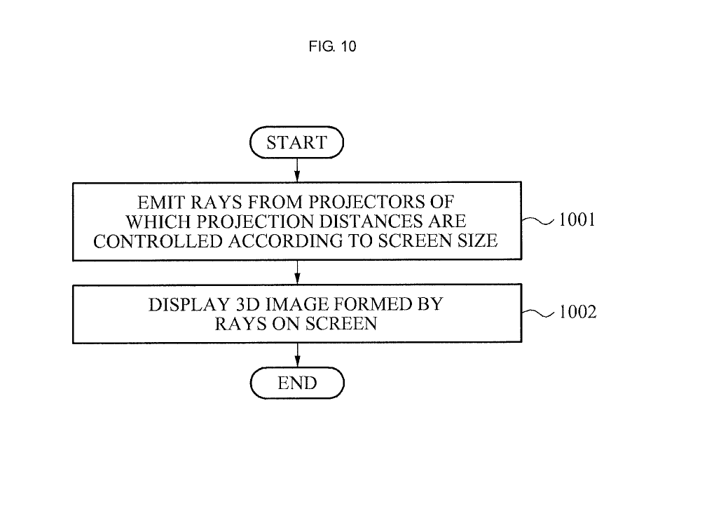

FIG. 10 illustrates a flowchart of a light field display method in which a projection distances of a plurality of projectors are controlled, according to one or more example embodiments.

The light field display method of FIG. 10 may be performed by a light field display, such as the light field display apparatus of FIG. 5 or the light field display apparatus of FIG. 6.

First, in operation 1001, the plurality of projectors of which projection distances are controlled according to a size of a screen may emit rays.

For example, the light field display apparatus may determine an arc of a circle as any one of a vertical length or a horizontal length of the screen. In addition, the light field display apparatus may generate an imaginary circle using the determined arc. The plurality of projectors may be arranged on the imaginary circle. Therefore, the projection distances of the plurality of projectors may be controlled to a distance from the projectors arranged on the imaginary circle to the screen.

Here, the plurality of projectors may be arranged on the imaginary circle with respect to a reference projector. For example, projectors disposed lower than the reference projector when arranged vertical to the screen may be disposed at a lower portion of the reference projector when arranged on the imaginary circle. Also, projectors disposed higher than the reference projector when arranged vertical to the screen may be disposed at an upper portion of the reference projector when arranged on the imaginary circle. When the plurality of projectors are vertically arranged forming uniform intervals and uniform angles, the projectors may be arranged on the imaginary circle maintaining uniform intervals and uniform angles.

As another example, the projection distances of the plurality of projectors may be controlled so that a 3D image emitted by the plurality of projectors and displayed on the screen is larger than the screen. That is, the projection distances may be controlled so that the size of the image 3D is larger than an entire surface area of the screen.

Here, the projection distances may be controlled according to a tilting value of each of the plurality of projectors. The tilting value may include tilt of each of the plurality of projectors with respect to the reference projector.

For example, with respect to projectors having a positive tilting value, the projection distances may be controlled in a direction toward the screen in proportion to the positive tilting value. That is, the projectors corresponding to the positive tilting value may be tilted up toward the reference projector at a lower portion of the reference projector.

With respect to projectors having a negative tilting value, the projection distances may be controlled in a direction away from the screen in proportion to the negative tilting value. That is, the projectors corresponding to the negative tilting value may be tilted down toward the reference projector at an upper portion of the reference projector.

In one or more embodiments, any apparatus, system, element, or interpretable unit descriptions herein include one or more hardware devices or hardware processing elements. For example, in one or more embodiments, any described apparatus, system, element, retriever, pre or post-processing elements, tracker, detector, encoder, decoder, etc., may further include one or more memories and/or processing elements, and any hardware input/output transmission devices, or represent operating portions/aspects of one or more respective processing elements or devices. Further, the term apparatus should be considered synonymous with elements of a physical system, not limited to a single device or enclosure or all described elements embodied in single respective enclosures in all embodiments, but rather, depending on embodiment, is open to being embodied together or separately in differing enclosures and/or locations through differing hardware elements.

In addition to the above described embodiments, embodiments can also be implemented through computer readable code/instructions in/on a non-transitory medium, e.g., a computer readable medium, to control at least one processing device, such as a processor or computer, to implement any above described embodiment. The medium can correspond to any defined, measurable, and tangible structure permitting the storing and/or transmission of the computer readable code.

The media may also include, e.g., in combination with the computer readable code, data files, data structures, and the like. One or more embodiments of computer-readable media include: magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Computer readable code may include both machine code, such as produced by a compiler, and files containing higher level code that may be executed by the computer using an interpreter, for example. The media may also be any defined, measurable, and tangible distributed network, so that the computer readable code is stored and executed in a distributed fashion. Still further, as only an example, the processing element could include a processor or a computer processor, and processing elements may be distributed and/or included in a single device.

The computer-readable media may also be embodied in at least one application specific integrated circuit (ASIC) or Field Programmable Gate Array (FPGA), as only examples, which execute (e.g., processes like a processor) program instructions.

While aspects of the present invention has been particularly shown and described with reference to differing embodiments thereof, it should be understood that these embodiments should be considered in a descriptive sense only and not for purposes of limitation. Descriptions of features or aspects within each embodiment should typically be considered as available for other similar features or aspects in the remaining embodiments. Suitable results may equally be achieved if the described techniques are performed in a different order and/or if components in a described system, architecture, device, or circuit are combined in a different manner and/or replaced or supplemented by other components or their equivalents.

Thus, although a few embodiments have been shown and described, with additional embodiments being equally available, it would be appreciated by those skilled in the art that changes may be made in these embodiments without departing from the principles and spirit of the invention, the scope of which is defined in the claims and their equivalents.

What is claimed is:

1. A light field display apparatus comprising:
a plurality of projectors to emit rays,
wherein positions of each of the plurality of projectors are controlled so that intervals between the rays displayed on the screen are substantially the same.

2. The light field display apparatus of claim 1, wherein arrangement orders of each of the plurality of projectors are different between even number rows and odd number rows.

3. The light field display apparatus of claim 1, wherein rows on which each of the plurality of projectors are arranged are repeatedly changed according to a predetermined row interval.

4. The light field display apparatus of claim 21, wherein projection distances of each of the plurality of projectors is controlled according to a size of the screen.

5. The light field display apparatus of claim 1, wherein positions of each of the plurality of projectors are controlled such that angles between the rays emitted toward the screen by each of the plurality of projectors are substantially the same.

6. The light field display apparatus of claim 1, further comprising:
a reflection mirror tilted by a predetermined angle with respect to the screen to reflect the rays emitted by the plurality of projectors.

7. A light field display apparatus comprising:
a plurality of projectors to emit rays,
wherein positions of each of the plurality of projectors are controlled so that angles between the rays emitted toward the screen by each of the plurality of projectors are substantially the same.

8. The light field display apparatus of claim 7, further comprising:
a first reflection mirror disposed at one side of the screen and tilted with respect to the screen by a predetermined angle, to reflect the rays emitted by each of the plurality of projectors; and
a second reflection mirror disposed at an opposite side of the screen and tilted with respect to the screen by a predetermined angle, to reflect the rays emitted by each of the plurality of projectors.

9. The light field display apparatus of claim 22, wherein projection distances of each of the plurality of projectors are controlled according to a size of the screen.

10. The light field display apparatus of claim 9, wherein positions of each of the plurality of projectors are controlled such that intervals between the rays displayed on the screen are substantially the same.

11. A light field display apparatus comprising:
a plurality of projectors to emit rays,
wherein projection distances of each of the plurality of projectors are controlled according to a size of the screen.

12. The light field display apparatus of claim 11, wherein the projection distances of each of the plurality of projectors are controlled such that each of the plurality of projectors are arranged on an imaginary circle having an arc length equal to a horizontal length or vertical length of the screen.

13. The light field display apparatus of claim 11, wherein
the projection distances are controlled such that each of the plurality of projectors are directed toward the screen or opposite to the screen according to a tilting value of the plurality of projectors, and
the tilting value includes tilt of each of the plurality of projectors with respect to at least one projector among the plurality of projectors arranged parallel toward the screen.

14. A light field display method comprising:
emitting rays from a plurality of projectors; and
displaying the rays emitted from each of the plurality of projectors on a screen,
wherein positions of each of the plurality of projectors are controlled such that intervals between the rays displayed on the screen are substantially the same.

15. The light field display method of claim 14, wherein arrangement orders of each of the plurality of projectors are different between even number rows and odd number rows.

16. The light field display method of claim 14, wherein rows on which each of the plurality of projectors are arranged are repeatedly changed according to a predetermined row interval.

17. The light field display method of claim 14, wherein projection distances of each of the plurality of projectors are controlled according to a size of the screen.

18. The light field display method of claim 14, wherein positions of each of the plurality of projectors are controlled such that angles between the rays emitted toward the screen by each of the plurality of projectors are substantially the same.

19. A light field display method comprising:
emitting rays from a plurality of projectors; and
displaying the rays emitted by each of the plurality of projectors on a screen,
wherein positions of each of the plurality of projectors are controlled so that angles between the rays emitted toward the screen by each of the plurality of projectors are substantially the same.

20. A light field display method performed by a light field display apparatus, comprising:
emitting rays from a plurality of projectors; and
displaying the rays emitted by each of the plurality of projectors on a screen,
wherein projection distances of each of the plurality of projectors are controlled according to a size of the screen.

21. The light field display apparatus of claim 1, further comprising a screen to display the rays emitted by each of the plurality of projectors.

22. The light field display apparatus of claim 7, further comprising a screen to display the rays emitted by each of the plurality of projectors.

23. A light field display method comprising:
emitting rays from a plurality of projectors; and
displaying the rays emitted from each of the plurality of projectors on a screen,
wherein arrangement orders of each of the plurality of projectors are different between even number rows and odd number rows.

24. A light field display method comprising:
emitting rays from a plurality of projectors; and
displaying the rays emitted from each of the plurality of projectors on a screen,
wherein rows on which each of the plurality of projectors are arranged are repeatedly changed according to a predetermined row interval.

25. The light field display apparatus of claim 7, wherein the angles between the rays are controlled to be substantially the same based on a center angle of an imaginary focus at which an imaginary extension line of the first reflection mirror and an imaginary extension line of the second reflection mirror meet.

26. The light field display method of claim 19, wherein the angles between the rays are controlled to be substantially the same based on a center angle of an imaginary focus at which an imaginary extension line of a first reflection mirror disposed at one side of the screen and tilted with respect to the screen by a predetermined angle and an imaginary extension line of a second reflection mirror disposed at an opposite side of the screen and tilted with respect to the screen by a predetermined angle meet.
